(19) United States
(12) Patent Application Publication
(10) Pub. No.: US 2013/0110614 A1
(43) Pub. Date: May 2, 2013

(54) Enhanced Campaign Contact Tracking

(71) Applicants: Dirk Wagner, Schiffweiler (DE); Martin Steiert, Heidelberg (DE)

(72) Inventors: Dirk Wagner, Schiffweiler (DE); Martin Steiert, Heidelberg (DE)

(73) Assignee: SAP AG, Walldorf (DE)

(21) Appl. No.: 13/287,465

(22) Filed: Nov. 2, 2011

(51) Int. Cl. G06Q 30/02

(52) U.S. Cl. 705/14.41

(57) ABSTRACT

The present disclosure describes methods, systems, and computer program products for providing enhanced campaign tracking One method includes identifying an inbound communication from a responding entity associated with a particular campaign, the inbound communication associated with at least one outbound communication associated with the particular campaign and identifying at least one selected response option in the inbound communication. The identified at least one selected response option is associated with a corresponding semantic meaning defined for the particular campaign. A new instance of a campaign inbound object associated with the identified inbound communication is instantiated, where the new instance of the campaign inbound object associated with a set of information related to the inbound communication. In some instances, the inbound communication may have a unique identifier associated with the responding entity that was included in an outbound communication associated with the campaign that was previously sent to the responding entity.

### TECHNICAL FIELD

The present disclosure relates to computer program products, computer systems, and computer implemented methods for providing enhanced marketing campaign contact tracking

### BACKGROUND

Campaign management includes design, execution, coordination, optimization, and monitoring of marketing campaigns. Generally, a campaign is a plan of action that comprises measures, communications, and operations used to execute and monitor marketing activities that are intended to allow a business to reach a defined goal. The campaign can cover measures within the campaign management process, such as outgoing and incoming channel determinations and/or options (e.g., email, letter, fax, phone call), assignment of forms and target groups, campaign execution, and response tracking

### SUMMARY

The present disclosure describes methods, systems, and computer program products for providing enhanced campaign tracking One method includes identifying an inbound communication from a responding entity associated with a particular campaign, the inbound communication associated with at least one outbound communication associated with the particular campaign and identifying at least one selected response option in the inbound communication. The identified at least one selected response option is associated with a corresponding semantic meaning defined for the particular campaign. A new instance of a campaign inbound object associated with the identified inbound communication is instantiated, where the new instance of the campaign inbound object associated with a set of information related to the inbound communication. In some instances, the inbound communication may have a unique identifier associated with the responding entity that was included in an outbound communication associated with the campaign that was previously sent to the responding entity.

While generally described as computer implemented software embodied on tangible media that processes and transforms the respective data, some or all of the aspects may be computer implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for implementing various features of a system providing enhanced campaign contact tracking and analysis.

FIG. 2A illustrates an example entity relationship model between business objects associated with campaign contact tracking

FIG. 2B is a diagram of a generic business object in a particular implementation of FIG. 1.

FIG. 3 is a flowchart of an example method for defining, or modeling, a campaign.

FIG. 4 illustrates an example process for outbound communication tracking during the execution of a particular campaign.

FIG. 5 illustrates an example inbound tracking method for tracking received inbound communications associated with a particular campaign.

FIG. 6 is a flowchart of an example method for storing information associated with inbound communications that are associated with a particular campaign.

FIG. 7 illustrates an example method for modeling a query associated with one or more campaigns.

FIGS. 8A-C illustrate example screenshots associated with the modeling of campaign-related queries.

FIGS. 9A-B. illustrate example screenshots associated with example use cases for campaign contact tracking operations.

### DETAILED DESCRIPTION

This disclosure generally relates to computer program products, computer systems, and computer implemented methods for providing enhanced marketing campaign contact tracking Specifically, tools and methods for tracking outbound and inbound messages and other communications associated with a particular campaign are provided, allowing users and businesses associated with the campaign to analyze and update the particular campaign as needed. Additionally, this disclosure describes tools and methods for including or associating possible responses and/or answers of contacted parties or entities with semantic attributes, thereby allowing received responses to include additional information than previously available. The results of the received responses can then be aggregated and analyzed, allowing the users, entities, and/or businesses associated with the campaign to review the results of the actual responses, as well as the underlying information provided by or associated with the actual responses in a single location or view.

Various terms associated with campaigns may be used herein. The following terms and/or phrases may be used within the present disclosure:
Campaign. Campaigns can be associated with and/or integrated into business applications, allowing for an enterprise, company, or other entity to perform various operations in association with a particular campaign. Those business processes may include marketing planning and budgeting, campaign planning, campaign development, segmentation, campaign execution, and campaign analysis. Marketing planning and budgeting may combine and coordinate initiatives and resources across an organization to condense planning and development cycles. The campaign planning business process can allow the organization to plan key figures for a campaign. For example, when planning a campaign, the organization may need or want to be able to analyze data and predict what the outcome would be under certain circumstances. The campaign development business process can allow for the use of visual tools to allow easier design of complex campaigns. The segmentation business process can be used to segment business partners into particular target groups, allowing for certain partners to be identified as targets of a particular campaign. The campaign execution business process can be associated with sending campaign-related messages and information to one of the various channels for execution. Once a campaign is planned, the campaign can be released, allowing the campaign execution business process to execute the campaign, such as by sending out designed messages and communications to members of a particular target group. The campaign analysis business process can validate, measure, and allow regiment of a particular campaign through monitoring analysis, allowing refinement of the particular campaign both during and after its execution.
Campaign Outbound. A campaign outbound is a contact to a customer or to a contact person of a customer, generated during campaign execution. In the present disclosure, the term “outbound” may be used as a short form for “campaign outbound.” The contact can be processed by and the campaign outbound sent via one of several channels (e.g., email, fax, letter, phone) related to some further constraints (e.g., date, contact permission, etc.).
Campaign Inbound. A campaign inbound is a reply to a campaign outbound or any further reaction of a customer or of a contact person of a customer to a campaign. In the present disclosure, the term “inbound” may be used as a short form for “campaign inbound.”
Target Group. A target group is a list of customers, prospects, external addresses (e.g., addresses bought from an address vendor), or contact person(s) to be contacted via marketing activities (e.g., outbounds).
Contact Tracking (CT) Tables. CT tables are used to keep track of business partner contacts that occur within a campaign by directly sending target groups to the channels or retrieving reactions to a campaign. In some instances, there are two separate tables: one for tracking campaign outbounds (CT-Outbound Table) and one for tracking campaign inbounds (CT-Inbound Table). The storage of contact tracking data can be implemented with secondary storage mechanisms, such as database tables.
Personalized Response Code (PRC). A PRC is a unique ID that represents the campaign and business partner relationship. It is a readable string that can be printed on the letters, included in faxes, or included in or embedded in emails. During the creation of inbounds, the PRC could be used to identify a specific outbound. This outbound, and thus its related information (e.g., particular campaign, an outbound channel, etc.), can then be linked to a new inbound created in response to the specific outbound.
Response Option. A response option is an option that specifies how a customer who has been contacted as part of a campaign can respond to that campaign. The response option may contain identifying and administrative information, as well as the possible options to respond to a campaign.
Mail Transfer Agent (MTA). An MTA (also commonly called mail server) is a computer program or software agent that transfers electronic mail messages from one computer to another via routing functionalities. The MTA may generally work in the background while the user interacts with another associated program, such as the user's email client (e.g., Microsoft Outlook®). One of the most popular MTAs is sendmail, which implements the standard SMTP mail transfer protocol. For example, the Microsoft Exchange® server contains an MTA. The MTA may be used to send one or more email outbounds associated with a particular campaign based on the associated target group members.
DSN (Delivery Status Notification). If an MTA cannot deliver a mail to the recipient or another MTA (for example, due to a faulty address), then the mail is returned to the sender as a DSN (Delivery Status Notification). In principle, these are also mails, but are structured differently from other mails. The DSN may be structured as follows:
   A “human-readable” part. This part may depend on the configuration of the answering mail server. For example, this part may state: “Sorry! Mail could not be delivered! Recipient is not . . . ”)
   A “machine-readable” part. This part may provide standardized error codes that can be used by the system to identify a particular issue or cause associated with the failed delivery.
   Original mail as attachment. In some instances, this part may just include the header of the original mail, while in others, the entirety of the original mail may be included.

Companies and entities associated with a marketing and/or information campaign desire a consolidated storage system and campaign status overview associated with each of their business partners and their related campaign data, including the results associated with any current and/or previous campaigns. This data may include a summary and/or detailed information on outgoing communications, as well as data associated with corresponding incoming communications from the individuals and/or entities within a particular target group. Analysis on this collected data can allow entities to modify, revise, and improve current and future campaigns as needed to improve results and provide more meaningful information.

In one example, multi-wave campaigns can be used and defined, where the type of action depends on the outbound status of a particular communication. For instance, if a particular target group member has not been contacted, then the process associated with the campaign may generate an initial message. If, however, the particular target group member has been contacted, a follow-up message can be generated. In a different example, actions associated with a multi-wave campaign may be based instead on an inbound status of the communications. For instance, if the target group member has responded, a particular action may be taken based on the response, while if the target group member has not responded, a follow-up message may be generated.

In another example, a consolidated system can allow for easy updating and identification of out-of-date or incorrect information associated with particular target group members. For example, in order to verify or check email addresses in external lists (i.e., purchased or otherwise obtained from outside vendors or entities), the consolidated outbound history and specific status of one or more outbounds can be analyzed to determine how many incorrect or out-of-date email addresses were provided (i.e., by determining the number of bounced email communications), and request a refund or other compensation in turn.

Further, a consolidated system can provide and allow for deeper analyses of campaign-related data. For example, reporting on campaign successes and failures, as well as response rates, can be provided by incorporating on-line transaction processing (OLTP) systems with the consolidated system. The OLTP systems can provide immediate feedback and information to users associated with the campaign, allowing portions of the campaign to be modified quickly in response to identified issues from the analysis. In addition to OLTP reporting, the consolidated system may also include an online analytical processing (OLAP) system, a category of software tools for providing analysis of data stored in a database. OLAP tools enable users to analyze different dimensions of multi-dimensional data, including time series and trend analysis views. The OLAP system and tools may allow for analysis of campaign life-cycle data and revenue and/or cost-based relevant areas of the campaign. In some instances, the analytical analysis can be performed in main memory using in-memory database techniques to improve performance and speed associated with the analysis.

In general, this description describes an architecture, system, and methods for enhanced campaign outbound and inbound tracking Campaign outbound and inbound tracking serves as a central storage within one or more CT tables. The CT tables can be used for marketing-related business partner contacts and can contain references to a particular campaign. Additional metadata and other information associated with a particular CT table or entry therein can be used to provide further information on inbound and outbound campaign correspondence. For instance, date/time information, a particular channel with which the business partner has been established, and campaign-related dates, as well as other relevant and suitable information, can be included within or associated with the CT tables. During an outbound tracking process, a particular business partner within a target group associated with the current campaign will be contacted. In response to this contact, an outbound CT table associated with the current campaign can be filled within the campaign execution's runtime. During an inbound tracking process, marketing documents (e.g., email activities, letter activities, leads, etc.) independent from a particular type of business transaction document or channel can be used to store relevant data in a corresponding inbound CT table associated with the current campaign.

During a campaign's execution, as well as after the campaign's completion, analysis of the contact tracking data can be provided by various analysis tools. In some instances, the analysis tools may be implemented based on secondary storage mechanisms such as database tables, as well as through main memory mechanisms through the use of in-memory technology and reporting mechanisms from providing real-time analysis. In some instances, relevant data can be extracted to OLAP systems, where reports can use aggregation, multi-dimensional calculations, and other suitable techniques to provide useful information on the corresponding campaign or set of campaigns. To enable real-time analysis with in-memory technology, particular views upon campaign relevant key figures (i.e., campaign response rates, failed outbound communications due to incorrect address data of the contact target group member, etc.) can be defined to allow relevant information to be processed immediately. Further, the data and corresponding analyses can be used both in cooperation with a campaign overview and to allow analysis reports to be accessible outside of the campaign. In addition, using in-memory query techniques, the data associated with the campaign can be easily shared and/or incorporated into other applications, as appropriate. Additional benefits and advantages will be apparent to persons of skill in the art.

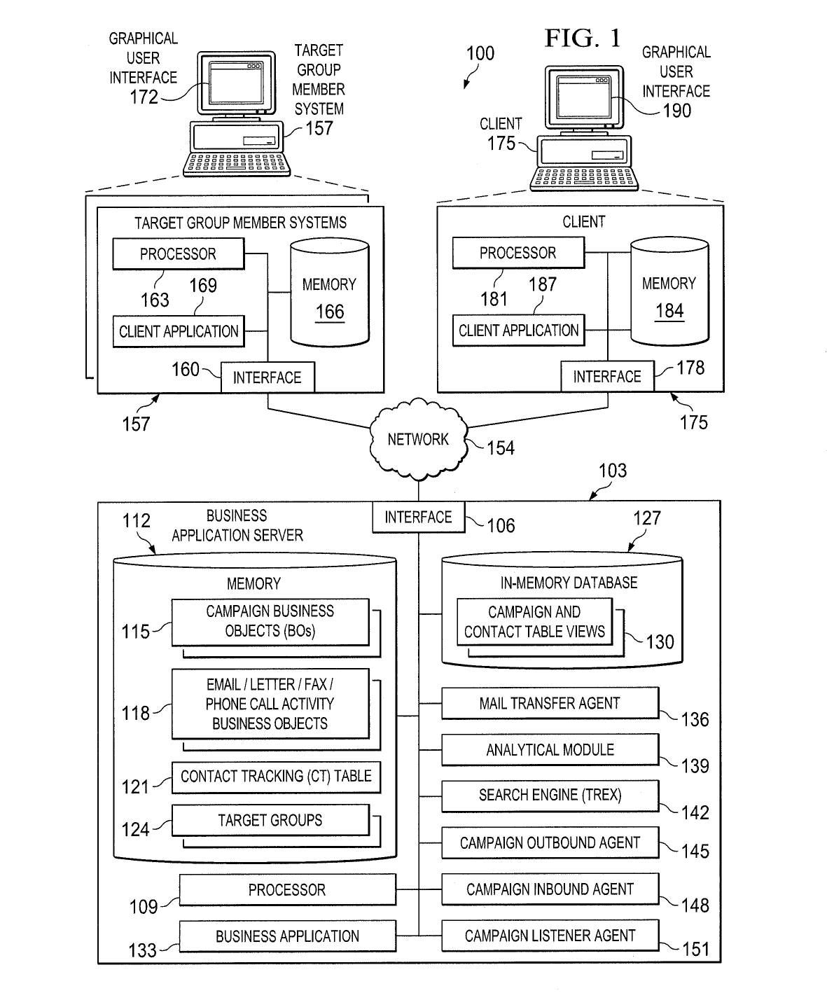

FIG. 1 illustrates an example environment 100 for implementing various features of a system providing enhanced campaign contact tracking and analysis. The illustrated environment 100 includes, or is communicably coupled with, a business application server 103, at least one target group member system 157, and at least one client 175. At least some of the communications between the business application server 103, the at least one target group member system 157, and the at least one client 175 may be performed across or via network 154. In general, environment 100 depicts an example configuration of a system for modeling, creating, implementing, and analyzing marking campaigns in a distributed environment and with two or more target group members, providing in-depth and, in some instances, real-time analysis to administrators and other individuals associated with particular campaigns managed in the illustrated environment 100. The environment 100 is an example, and in alternative implementations, the elements illustrated in FIG. 1 may be included in or associated with different and/or additional servers, clients, networks, and locations other than those as shown. For example, one or more of the components illustrated within the business application server 103 may be located in multiple or different servers, cloud-based networks, or other locations accessible to the business application server 103 (e.g., either directly or indirectly via network 154).

In general, the business application server 103 is any server or system that stores, manages, and executes functionality associated with campaign creation, modeling, maintenance, and analysis. Additionally, the business application server 103 may execute one or more business applications 133, as well as other related applications, programs, and modules. For example, the business application server 103 may be a Java 2 Platform, Enterprise Edition (J2EE)-compliant application server that includes Java technologies such as Enterprise JavaBeans® (EJB), J2EE Connector Architecture (JCA), Java® Messaging Service (JMS), Java® Naming and Directory Interface (JNDI), and Java® Database Connectivity (JDBC). In some instances, the business application server 103 may store a plurality of various applications, while in other instances, the business application server 103 may be dedicated servers meant to store and execute campaign-related operations and functionality. In some instances, the business application server 103 may comprise a web server or be communicably coupled with a web server, where one or more of the business applications 133 associated with the business application server 103 represent web-based (or web-accessible) applications accessed and executed through requests and interactions received on or via the client 175, executing a client application 187 operable to interact with the programmed tasks or operations of the corresponding campaign-related functionality and/or one or more business applications 133.

At a high level, the business application server 103 comprises an electronic computing device operable to receive, transmit, process, store, or manage data and information associated with the environment 100. The business application server 103 illustrated in FIG. 1 can be responsible for receiving application requests from one or more clients 175 (as well as any other entity or system interacting with the business application server 103, including desktop or mobile client systems, as well as communications from one or more target group member systems 157), responding to the received requests by processing said requests in the campaign-related functionality and/or the associated business application 133 (which may include campaign-related operations and functionality), and sending the appropriate responses from the appropriate component back to the requesting client 175 or other requesting system. Components of the business application server 103 can also process and respond to local requests from a user locally accessing the system. Accordingly, in addition to requests from the clients 175 illustrated in FIG. 1, requests associated with a particular component may also be sent from internal users, external or third-party customers, and other associated business applications, business processes, as well as any other appropriate entities, individuals, systems, or computers. In some instances, the business application 133 and/or the campaign-related functionality may be web-based applications executing functionality associated with a networked or cloud-based business process.

As used in the present disclosure, the term “computer” is intended to encompass any suitable processing device. For example, although FIG. 1 illustrates a single business application server 103, environment 100 can be implemented using any number of servers, as well as computers other than servers, including a server pool. Indeed, the business application server 103 may be any computer or processing device such as, for example, a blade server, general-purpose personal computer (PC), Macintosh®, workstation, UNIX®-based workstation, or any other suitable device. In other words, the present disclosure contemplates computers other than general purpose computers, as well as computers without conventional operating systems. Further, the illustrated business application server 103 may be adapted to execute any operating system, including Linux, UNIX®, Windows®, Mac® OS, or any other suitable operating system.

In the illustrated implementation of FIG. 1, the business application server 103 includes an interface 106, a processor 109, a memory 112, an in-memory database 127, a business application 133, a mail transfer agent 136, an analytical module 139, a search engine 142, a campaign outbound agent 145, a campaign inbound agent 148, and a campaign listener agent 151. In some instances, the business application server 103 and its illustrated components may be separated into multiple components executing at different servers and/or systems. For example, while FIG. 1 illustrates the business application 133 and the campaign-related modules and applications (e.g., the mail transfer agent 136, the analytical module 139, the search engine 142, the campaign outbound agent 145, the campaign inbound agent 148, and the campaign listener agent 151) as separate components, other example implementations can include the various campaign-related modules and applications within the business application 133, as a part of the business application's functionality, while also illustrating the business application 133 and/or the campaign-related modules and applications within a separate system. Thus, while illustrated as a single component in the example environment 100 of FIG. 1, alternative implementations may illustrate the business application server 103 as comprising multiple parts or portions, accordingly.

FIG. 1 depicts a server-client environment, but could also represent a cloud computing network. Various other implementations of the illustrated environment 100 can be provided to allow for increased flexibility in the underlying system, including multiple business application servers 103 performing or executing one or more additional or alternative instances of the business application 133 and the campaign-related modules and applications for one or more different platforms, as well as multiple instances of the business application 133 and the campaign-related functionality. In those instances, the different business application servers 103 may communicate with each other via a cloud-based network or through the connections provided by network 154.

The interface 106 is used by the business application server 103 to communicate with other systems in a client-server or other distributed environment (including within environment 100) connected to the network 154 (e.g., one of the clients 175, one or more clients 175, one or more target group member systems 157, as well as other systems communicably coupled to the network 154). The interface 106 generally comprises logic encoded in software and/or hardware in a suitable combination and operable to communicate with the network 154. More specifically, the interface 106 may comprise software supporting one or more communication protocols associated with communications such that the network 154 or the interface's hardware is operable to communicate physical signals within and outside of the illustrated environment 100.

Generally, the business application server 103 may be communicably coupled with a network 154 that facilitates wireless or wireline communications between the components of the environment 100 (i.e., between the business application server 103 and different target group member systems 157 and/or one or more clients 175), as well as with any other local or remote computer, such as additional clients, servers, or other devices communicably coupled to network 154, including those not illustrated in FIG. 1. In the illustrated environment, the network 154 is depicted as a single network, but may be comprised of more than one network without departing from the scope of this disclosure, so long as at least a portion of the network 154 may facilitate communications between senders and recipients. In some instances, one or more of the components associated with the business application server 103 may be included within the network 154 as one or more cloud-based services or operations.

The network 154 may be all or a portion of an enterprise or secured network, while in another instance, at least a portion of the network 154 may represent a connection to the Internet. In the illustrated example, at least a portion of the network 154 includes a portion of a cellular or mobile data network or other network capable of relaying short message service (SMS) messages. In some instances, a portion of the network 154 may be a virtual private network (VPN). Further, all or a portion of the network 154 can comprise either a wireline or wireless link. Example wireless links may include 802.11a/b/g/n, 802.20, WiMax, and/or any other appropriate wireless link. In other words, the network 154 encompasses any internal or external network, networks, sub-network, or combination thereof operable to facilitate communications between various computing components inside and outside the illustrated environment 100. The network 154 may communicate, for example, Internet Protocol (IP) packets, Frame Relay frames, Asynchronous Transfer Mode (ATM) cells, voice, video, data, and other suitable information between network addresses. The network 154 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the business application server 103 includes a processor 109. Although illustrated as a single processor 109 in the business application server 103, two or more processors may be used according to particular needs, desires, or particular embodiments of environment 100. The processor 109 may be a central processing unit (CPU), a blade, an application specific integrated circuit (ASIC), a field-programmable gate array (FPGA), or another suitable component. Generally, the processor 109 executes instructions and manipulates data to perform the operations of the business application server 103 and, specifically, the functionality associated with the corresponding business application 133 and the other campaign-related modules, applications, and functionality. In one implementation, the server's processor 109 executes the functionality required to receive and respond to requests and instructions from the clients 175 and target group member systems 157, as well as the functionality required to perform the operations of the associated business application 133 and the campaign-related modules and applications, among others.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 109 executes the corresponding business application 133 and other campaign-related components stored on the associated business application server 103. In some instances, a particular business application server 103 may be associated with the execution of two or more business applications 133 and/or campaign-related modules (and other related components), as well as one or more distributed applications executing across two or more servers executing the functionality associated with the business application server 103.

At a high level, each business application 133 is any application, program, module, process, or other software that may execute, change, delete, generate, or otherwise manage information associated with a particular business application server 103, and in some cases, a business process performing and executing business process-related events. In particular, business processes communicate with other users, applications, systems, and components to send, receive, and process events. In some instances, a particular business application 133 may operate in response to and in connection with one or more requests received from an associated client 175, a particular target group member system 157, or another remote client or system. Additionally, a particular business application 133 may operate in response to and in connection with one or more requests received from other business applications 133 external to the business application server 103. In some instances, the business application 133 may request additional processing or information from an external system or application. In some instances, each business application 133 may represent a web-based application accessed and executed by remote clients 175 (or other systems) via the network 154 (e.g., through the Internet, or via one or more cloud-based services associated with the business application 133). Further, while illustrated as internal to the business application server 103, one or more processes associated with a particular business application 133 may be stored, referenced, or executed remotely. For example, a portion of a particular business application 133 may be a web service that is remotely called, while another portion of the business application 133 may be an interface object or agent bundled for processing at a remote system (not illustrated), a particular target group member system 157, or a particular client 175 (e.g., the client application 187). Moreover, any or all of a particular business application 133 may be a child or sub-module of another software module or enterprise application (not illustrated) without departing from the scope of this disclosure. Still further, portions of the particular business application 133 may be executed or accessed by a user working directly at the business application server 103, as well as remotely at a corresponding client 175 (or another suitable remote location). In some instances, the business application 133 may be an application related to marketing campaigns, providing tools for modeling, creating, and working with marketing campaigns. For example, the business application 133 may a part of a customer relationship management application or system.

The business application server 103 includes various other campaign- related modules, such as the mail transfer agent 136, the analytical module 139, the search engine 142, the campaign outbound agent 145, the campaign inbound agent 148, and the campaign listener agent 151. The various components, while illustrated individually, may be grouped together as a single component in alternative implementations, as well as components or parts of the business application 133.

The mail transfer agent (MTA) 136 acts a module for transferring electronic mail messages from one system to another via routing functionalities. In many cases, the MTA 136 may work in the background, and can allow various outbound messages or communications associated with campaigns to be sent to one or more target group member systems 157 as identified for a particular campaign instance. The MTA 136 may be inherently included within the business application server 103, while in other instances, the MTA 136 may be an application created specifically for campaign-related tasks and operations.

The analytical module 139 comprises a module for allowing OLTP and OLAP processing of information associated with one or more executing or completed campaigns. The analytical module 139 can access the contact tracking (CT) table 121 as appropriate to identify and retrieve information relevant to one or more campaigns. In some instances, the analytical module can provide information for users related to a particular campaign or campaign execution during that campaign's operations. In some instances, the analytical module 139 may be used to transfer information from a persistent memory (i.e., memory 112) into one or more in-memory databases 127, allowing for specific views on campaign-related data and information to be provided in real-time. The analytical module 139 may also be able to access the corresponding in-memory database 127 to access one or more campaign and/or contact table views 130 on particular data to provide up-to-date and relevant information to users regarding various campaigns. The analytical module 139 can, in some instances, be associated with a web site or other presentation of campaign-related data to allow users to define one or more queries, or views, of campaign-related data associated with the campaign and/or information within the contact tracking table 121.

The search engine 142 provides tools and operations for searching and browsing through campaign-related data and information. Users, either locally or through, for example, a particular client 175, can submit requests for information via the search engine 142 and its associated functionality. Requests to the search engine 142 can be defined by filters, intervals, aggregates, and/or any attribute associated with a particular individual campaign or set of campaigns. Search results can be delivered via high performance, in-memory access to the requester. In some instances, the analytical module 139 may be used in connection with the search engine 142 to provide OLAP and OLTP services to requesters. If the information is associated with information stored within the in-memory database 127, the information may be available in near real-time. Alternatively, the search engine 142 can access, if necessary, the contact tracking table 121, the set of campaign business objects 115, and/or any other available data to identify information corresponding to a particular search query and term. When used in combination with the analytical module 139, advanced metrics and calculations can be performed on a continuous or interval-based basis, with users accessing the data upon request via the search engine 142. By using the analytical module 139 to keep updated results, the search engine 142 can provide near-instant access to relevant data. For example, the analytical module 139 can analyze the results of an executing campaign to determine or identify potential hot leads. A corresponding search for hot leads by the search engine 142 can access this information immediately upon request and return the information to the requesting user.

The campaign outbound agent 145 comprises an agent, application, module, daemon, or other software for handling outbound communications associated with a campaign. The campaign outbound agent 145 can access information associated with a particular campaign (in some instances, stored within one or more campaign business objects (BOs) 115) to determine how a communication is to be sent to a third party. The third party to whom the communication is to be sent can be defined by a target group associated with the corresponding campaign which defines the individuals and addresses to which the campaign communication is to be sent. In some instances, the information defining how and to whom the communication is to be sent may be stored in or referenced by the contact tracking (CT) table 121. When a particular campaign is executed, the campaign outbound agent 145 can determine that a communication is to be sent. In some instances, information regarding how, when, and to whom the communication is to be sent may be provided to the campaign outbound agent 145. In other instances, the campaign outbound agent 145 may access the CT table 121 and corresponding campaign BO 115 to identify information regarding the appropriate communications to be sent. The campaign outbound agent 145 can, in some instances, identify the contents of the communication, the channel through which the message is to be sent, and the addressing or routing information associated with the message. Once that information is identified, the campaign outbound agent 145 can instantiate and send the corresponding communication. Communications can be sent via any suitable medium, including email, phone, fax, or letters, among others. For emails, the campaign outbound agent 145 can create the corresponding outbound email associated with the communication, route the message through the mail transfer agent 136, and send the outbound communication to the appropriate entity. For letters, the campaign outbound agent 145 can generate, or instruct a user to generate, the appropriate letter and correspondence for mailing to the recipient. For fax communication, the campaign outbound agent 145 can cause a fax program or application to generate an appropriate fax and send that fax to the appropriate recipient. For phone communication, the campaign outbound agent 145 can initiate, or request a customer service agent to initiate, a call with the appropriate recipient. In those instances, the phone call may be an automated call, or the call may be handed over to a customer service agent upon making a connection with the appropriate recipient.

The campaign outbound agent 145 may be capable of performing additional tasks and operations. For instance, the campaign outbound agent 145 may be able to check and verify the addressability of account and contact information for members of a particular target group assigned to a campaign. In one example, the email addresses associated with one or more of the email correspondence may be analyzed to determine if the email address is valid. The campaign outbound agent 145 can also generate or otherwise assign or associate a unique personalized response code (PRC) to each outgoing communication. A PRC is a unique identifier representing the campaign with which a particular communication is associated with, as well as a number or identifier that can be used to identify a particular target group member with whom the communication is related. The PRC may be a readable string that can be printed on letters, included in faxes, or included or embedded within emails. In some instances, the PRC may be used as a contact reference number during a phone call. When return, or inbound, communications are provided by a target member, the PRC may be included within the response. Using the PRC, particular inbound communications can then be linked to a specific outbound communication, allowing for immediate tracking and analysis of contacts upon return, or inbound, communication. In another example, the campaign outbound agent 145 may also create a corresponding outbound record for entry into the corresponding CT table 121 when communications are sent and/or prepared. The outbound record entry can include metadata related to the outbound communication including, but not limited to, the status of the outbound, the date/time of sending the outbound, the channel through which the outbound was sent, the target group member to whom the communication was sent, and the PRC associated with the outbound communication, among others.

In some instances, outbound communications can include one or more questions or requests for information, where each question has a particular set of answer choices associated with the question. In general, each question may include one or more response options, or options that specify how a customer or target group member who has been contacted as part of a campaign can respond to that campaign. In some instances, a particular communication may have a single question for which one set of campaign responses are defined. Further, in some instances, responding to or not responding to a particular outbound communication may comprise the particular response option to a campaign communication. In some instances, the outbound communication may include the set of possible responses that are selectable by those receiving the communication. The response options can include natural language responses, for example, “Yes, I'm interested,” “Contact me again at a later date,” or “No, thank you.” These natural language responses can then be associated with a particular semantic meaning or translation. For the three examples above, the semantic meanings may be “Positive,” “Neutral,” and “Negative.” By associating these semantic meanings with the natural language responses, the information associated with the response options can provide further description without requiring later translation of received responses. These results can be stored within the corresponding CT table 121 or response-related business objects, and can be used later to further analyze the relative success and results of a particular campaign. The response option semantic (i.e., neutral, negative, or positive, etc.) can later be used and/or selected via a query mechanism used to define follow-up scenarios. For example, each of the “neutral” responses to a specific campaign can be collected in order to set up an additional campaign with the purpose to offer further information through a separate channel, such as a phone call-based campaign, with the goal being to transform the neutral responses into positive ones.

The campaign inbound agent 148 comprises an agent, application, module, daemon, or other software for handling inbound communications associated with a campaign. The campaign inbound agent 148 can review inbound communications, or metadata or other information associated with the inbound communications, to analyze and associate inbound communications with previously-sent outbound communications. In instances where the inbound communication is written, the inbound agent 148 can perform an analysis of the inbound communication to identify the contents of the communication. In some instances, the campaign inbound agent 148, or a related component, can perform an optical character recognition (OCR) process, where appropriate (i.e., an incoming fax or letter), to make the inbound communication computer readable and understandable. If the inbound communication is by telephone or other verbal means, a customer service agent or other representative can record the contents of the conversation and provide those to the campaign inbound agent 148, as appropriate. The campaign inbound agent 148 can identify the PRC associated with the inbound communication, and can, in some instances, access the CT table 121 to identify the corresponding outbound communication based on the unique PRC. An inbound table entry can be written to the CT table 121 based on information received from the inbound communication, and can include a defined relationship with the corresponding outbound communication and stored within the inbound record. In general, campaign inbound communications comprise a reply to a campaign outbound or any further reaction of a customer or of a contact person of a customer or target group member to a campaign. In some instances, the campaign inbound agent 148 may be associated with a call center providing a centralized location for receiving communications. For example the call center can receive phone calls, faxes, and letters in response to a campaign, and input the relevant information into the campaign inbound agent 148 or other appropriate application associated therewith. Campaign inbound agents 148 could also be used to trigger bounce-management rule frameworks. For instance, if soft bounces (i.e., out-of-office messages and mailbox-full reply emails) are tracked, those messages may normally not be further processed and could be removed or sorted out of the campaign analysis. The bounce-management rules can perform the extraction, removal, and/or sorting with a defined rule set to avoid further processing, such that the corresponding inbound agent 148 can trigger the bounce-management for incoming responses.

The campaign listener agent 151 comprises an agent, application, module, daemon, or other software for identifying modifications to relevant entries within the CT table 121 and/or one or more business objects associated with responses to a marketing campaign. If modifications are made to relevant entries or business objects, the campaign listener agent 151 can update the corresponding entries within the in-memory database 127. In some instances, the relevant entries and/or response business objects may be those for which a particular query or view 130 has been previously defined using the analytical module 139. The contents of the identified modifications can be automatically replicated from memory 112 to the in-memory database 127, thereby making the modifications available for in-memory operations, reporting, and analysis. In general, the campaign listener agent 151 may only be relevant for information associated with inbound tables within the CT table 121 and/or incoming response-related business objects and their attributes.

FIG. 1 further includes memory 112. Memory 112 of the business application server 103 can store data and program instructions, business objects related to one or more campaigns, campaign definitions, information relevant to target groups associated with particular campaigns, and information on both sent and received communications associated with campaigns, among others. Memory 112 may include any memory or database module and may take the form of volatile or non-volatile memory including, without limitation, magnetic media, optical media, random access memory (RAM), read-only memory (ROM), removable media, or any other suitable local or remote memory component. The memory 112 may store various objects, object models, and data, including classes, frameworks, applications, backup data, business objects, jobs, web pages, web page templates, database tables, and any other appropriate information including any parameters, variables, algorithms, instructions, rules, constraints, or references thereto associated with the purposes of the business application server 103, campaign-related modules and operations, and associated functionality. In some implementations, including a cloud-based system, some or all of memory 112 may be stored remote from the business application server 103, and communicably coupled to the business application server 103 for usage. Some or all of the elements illustrated within memory 112 may be stored external to memory 112. Additionally, memory 112 may be distributed among a plurality of physical and/or virtual locations. As illustrated, memory 112 includes a set of campaign business objects (BOs) 115, a set of response- related activity business objects 118, the CT table 121, and a set of target groups 124.

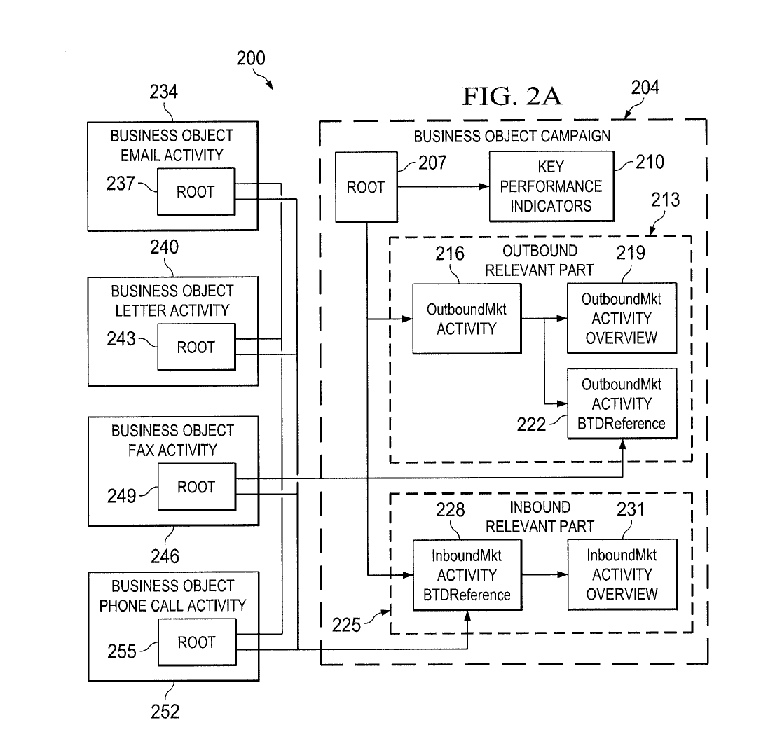

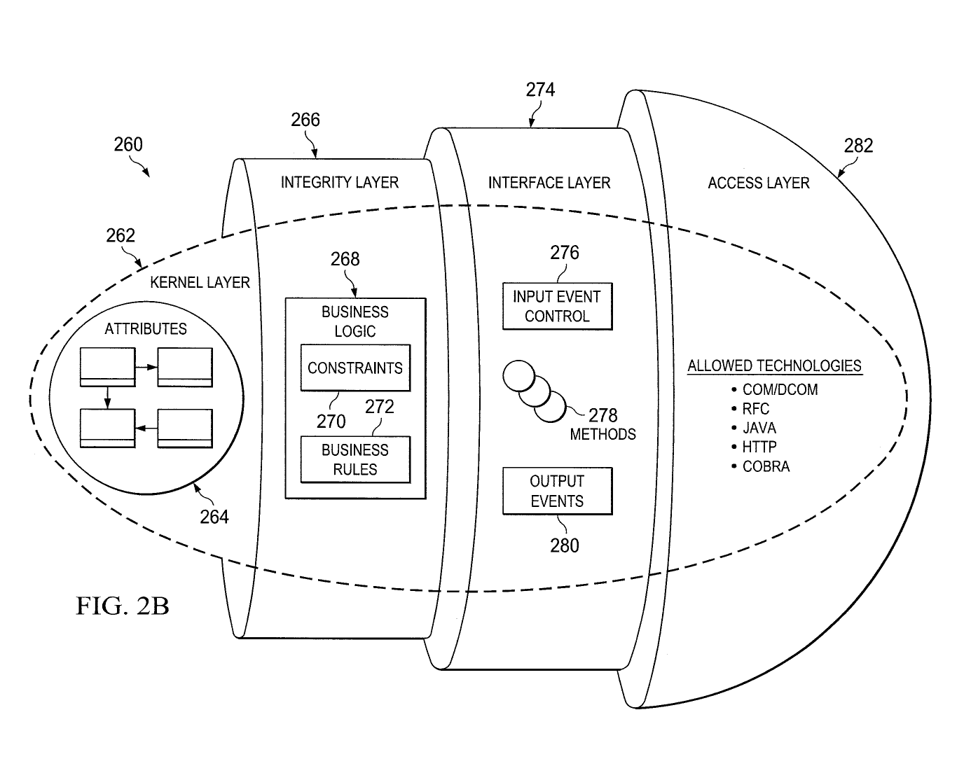

FIG. 2B illustrates the structure of a generic business object 260 in environment 100. In general, the overall structure of the business object model ensures the consistency of the interfaces that are derived from the business object model. The derivation helps ensure that the same business-related subject matter or concept can be represented and structured in the same way in various interfaces. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

A business object is a capsule with an internal hierarchical structure, behavior offered by its operations, and integrity constraints. Business objects are semantically disjointed, i.e., the same business information is represented once. A business object may be defined such that it contains multiple layers, such as in the example business object 260 of FIG. 2A. The example business object 260 contains four layers: the kernel layer 262, the integrity layer 266, the interface layer 274, and the access layer 282. The innermost layer of the example business object is the kernel layer 262. The kernel layer 262 represents the business object's 260 inherent data, containing various attributes 264 of the defined business object. The second layer represents the integrity layer 266. In the example business object 260, the integrity layer 266 contains the business logic 268 of the object. Such logic may include business rules 272 for consistent embedding in the environment 100 and the constraints 270 regarding the values and domains that apply to the business object 260. Business logic 268 may comprise statements that define or constrain some aspect of the business, such that they are intended to assert business structure or to control or influence the behavior of the business entity. It may pertain to the facts recorded on data and constraints on changes to that data. In effect, business logic 268 may determine what data may, or may not, be recorded in business object 260. The third layer, the interface layer 274, may supply the valid options for accessing the business object 260 and describe the implementation, structure, and interface of the business object to the outside world. To do so, the interface layer 274 may contain methods 278, input event controls 276, and output events 280. The fourth and outermost layer of the business object 260 in FIG. 2B is the access layer 282. The access layer 282 defines the technologies that may be used for external access to the business object's 260 data. Some examples of allowed technologies may include COM/DCOM (Component Object Model/Distributed Component Object Model), CORBA (Common Object Request Broker Architecture), RFC (Remote Function Call), Hypertext Transfer Protocol (HTTP) and Java, among others. Additionally, business objects 260 of this embodiment may implement standard object-oriented technologies such as encapsulation, inheritance, and/or polymorphism.

Returning to FIG. 1, several types of business objects are illustrated within memory 112. First, a set of campaign BO instances 115 are illustrated. In general, the campaign BO instances 115 each define a set of details regarding a particular campaign, including a set of measures for execution and monitoring marketing activities that are intended to reach a particular goal for the campaign. Each campaign BO instance 115 can define the measures relevant to a particular campaign management process, such as channel determination (e.g., email, letter, fax, phone call, etc.), the assignment of particular forms and response options for a particular campaign, the assignment of specific entities and/or target groups to a campaign, defined rules and operations for campaign execution, and methods of response tracking for inbound communications received from members of the target group. Each campaign BO instance 115 may be based on an underlying campaign BO, which can be used as a basis that defines the underlying attributes, business logic and rules, methods, inputs, outputs, and communication technologies that can be used by BO instances instantiated from the campaign BO. By modifying the instantiated attributes of a particular campaign BO instance 115, users and marketing administrators can modify and manipulate the operation, contents, and details of a particular campaign. Additional details of the campaign BO 115 are described in FIG. 2A. Additionally, attachments and other documents can also be assigned to a campaign. A set of response options could be assigned to a particular campaign, along with the possibility to assign a particular response option as a default value (can be defaulted in the actual response of the business partner, e.g., “positive” semantic response option corresponds to the response option “I'd like to participate” for an invitation campaign to an event).

Similar to the campaign BOs 115, the set of response-related activity BOs 118 are business objects associated with received responses. For each response received, a new activity BO instance 118 can be instantiated. The activity BOs 118 can provide operations and actions associated with the received responses, and can be related to the corresponding campaign BOs 115 to allow for the information to be incorporated in the campaign results. In some instances, the activity BOs 118 can perform operations for updating at least a portion of the CT table 121 entries that are associated with a particular campaign. As illustrated in FIG. 2A, several types of activity BOs 118 may be provided or available, including, as illustrated, an email activity BO 234, a letter activity BO 240, a fax activity BO 246, and a phone call activity BO 252. For each of the activity BOs 118, as well as the campaign BO 115, particular nodes within the corresponding business object can be represented as or identified by a database table, such as those provided by or within the CT table 121. The campaign listener agent 151, for instance, could be actively listening or following changes to a particular response-related business object, as well as particular fields associated with inbound communications (i.e., responses) within the CT table 121.

Memory 112 also includes a set of target groups 124, where each target group 124 can include a list of one or more customers, prospects, external addresses (e.g., addresses bought from an address vendor), or contact person(s) to be contacted via marketing activities (e.g., outbounds) associated with various campaigns. In some instances, the members of some target groups 124 may be predefined based on a certain set of characteristics (e.g., previous customers) or on a common origin (e.g., provided by a particular address or contact vendor). Alternatively, some target groups 124 can be manually defined when a campaign is being generated. Generally, the target groups 124 illustrated in FIG. 1 represent sets of contact information and entity-related data that can be used to identify particular campaigns that list members should be associated with, as well as information on how to contact those target group 124 members once they are associated with a particular campaign. In some instances, particular target groups 124 may be used in a plurality of campaign instances or scenarios, while in others, a particular target group 124 may only be used once, or not at all. When a particular campaign instance is executed, the target group 124 associated with the campaign instance can be read (e.g., by the campaign outbound agent 145) to address outbound communications.

The business application server 103 is illustrated as including the in-memory database 127. In alternative implementations, the in-memory database 127 may be located external to the business application server 103 and communicably coupled to the business application server 103 through the network 154. The illustrated in-memory database 127 may include integrated processing, i.e., all business and/or analytic operations done in processing memory. Moreover, content from business content sources (described more fully below) may be replicated from one or more transactional systems (e.g., the CT table 121 and the analytical module 139 coupled to the network 154) to the in-memory database 127 immediately. Thus, the in-memory database 127, in some aspects, may handle the analytical systems for all business data in real-time, as opposed to, for instance, computational processing systems that have separate transactional and analytical systems that connect through relational databases (i.e., relational databases stored on magnetic memory that require a process, e.g., extract, transform and load (ETL), to transfer data from one system to another not in real time, but with a delay of an hour, day, week, or longer).

In some embodiments, the in-memory database 127 may expose business data and capabilities to improve solutions and analysis for end users (e.g., the clients 175). The in-memory database 127 may reside on top of or be associated with a computational engine (e.g., the analytical module 139 in the business application server 103 or otherwise) that facilitates fast manipulations on large amounts of business data and/or replication of entire business suite information. Thus, in some embodiments, the in-memory database 127 may provide for the following design principles/concepts: business data in real-time (e.g., graphical user interface (GUI) patterns for constantly updated business data); well-modeled tables and data cubes (e.g., in order to provide semantic services); a highly parallelized computational engine (e.g., for computationally intensive GUI patterns such as real time alerts and/or suggestions); close coupling of business logic and business data (e.g., eliminating indexing and caching).

The illustrated in-memory database 127 stores one or more data objects that may include and/or reference a variety of objects that store and/or include business data, including objects associated with the various executed and executing campaigns. The in-memory database 127 may comprise a secondary persistency for historical information in addition to the primary persistency of the original business object data stored in memory 112. In some instances, the data objects may include data cubes, such as OLAP cubes. The data cubes may consist of a data structure that allows analysis of data, in some cases, faster than data stored in relational databases. The data cube may also allow manipulation and/or analysis of the data stored in the cube from multiple perspectives, e.g., by dimensions, measures, and/or elements of the cube. A cube dimension defines a category of data stored in the cube, for example, a time duration of certain business data, a product or service, business user roles, and a variety of other categories. In other words, a cube dimension may be one way to slice business data stored in the cube according to some business logic (e.g., logic within and/or associated with the contextual workspace modules). In some instances, the data cube may have three dimensions, but any number of dimensions may be designed into the cube (e.g., a hypercube).

A cube measure may be a fact, such as a numeric fact, that is categorized into one or more dimensions. Measures may include, for example, specific campaign responses according to a set period of time. Measures may also include, for example, overall response rate for a particular subset of a target group associated with a campaign or set of campaigns, as well as other suitable measures. In short, measures may include any appropriate business data that may be manipulated according to business logic to assist or support the business enterprise.

One or more functions may be performed on a data cube. For instance, the data cube may be pivoted, in various ways. Each pivot provides the business user with a distinct view of particular business data stored in the cube. For instance, in one view, a business user may be presented with sales data of a specific data within a particular geographic region across a particular time period with a particular focus on the sales vs. geography relationship. In another view, the same data (e.g., the same measures and elements) may be presented with a different focus, e.g., the sales vs. time period relationship. In some aspects, pivoting a data cube in real-time may allow the business user to more efficiently analyze the business data.

Other functions performable on data cubes may be, for instance, slice, dice, drill down/up, and roll-up. A slice operation identifies a subset of a multi-dimensional array corresponding to a single value for one or more members of the cube dimensions not in the subset. A dice operation is a slice operation on more than two dimensions of a data cube (or more than two consecutive slices). A drill down/up operation allows the business user to navigate the data cube's levels of data to reveal levels containing the most summarized (up) data to the most detailed (down) data. A roll-up operation involves computing all of the data relationships for one or more dimensions of the data cube.

As illustrated in FIG. 1, the in-memory database 127 can include a set of campaign and contact table views 130 that can provide up-to-date reports, aggregations, and sets of information associated with particular portions of the data relevant to one or more campaigns. The views 130 illustrated in FIG. 1 can be based on one or more predefined queries with search and return parameters. The defined queries can work with information that is updated within the in-memory database 127 based on operations performed, for example, by the analytical module 139 and/or search engine 142. Once particular queries are added, these modules, along with the campaign listener agent 151, can ensure that a current set of information on particular campaign data is updated within the in-memory database 127 and reflected through the defined views 130. When a relevant attribute or other data within the CT table 121 or other location is modified, the relevant views 130 within the in-memory database 127 can be updated immediately. When a client 175 or other user submits a request to view information associated with a particular query or view 130, the information from the in-memory database 127 and corresponding view 130 can be accessed immediately and a response provided in almost real-time.

The illustrated environment 100 of FIG. 1 further includes one or more target group member systems 157 associated with particular campaigns. Different target group members may have systems 157 of varying specifications. Each target group member systems 157 may be any computing device operable to connect to or communicate with at least the business application server 103 using a wireline or wireless connection via the network 154, or another suitable communication means or channel. In some instances, the target group member systems 157 may be a part of or associated with a business process involving the business applications 133, or alternatively, a target group member associated with a particular campaign to which a campaign outbound has been or is to be sent. As illustrated, a particular target group member system 157 may include an interface 160, processor 163, memory 166, client application 169, and GUI 172. The interface 160, processor 163, and memory 166 may be similar to or different than those described in relation to the business application server 103. The client application 169 may be a web browser, a dedicated application associated with the business application server 103, or any other suitable application that can allow the target group member system 157 to view outbound communications and response by providing inbound communications.

In general, each target group member system 157 may comprise an electronic computer device operable to receive, transmit, process, and store any appropriate data associated with the environment 100 of FIG. 1. It will be understood that there may be any number of target group member system 157 associated with, or external to, environment 100. For example, while illustrated environment 100 includes a single target group member system 157, alternative implementations of environment 100 may include multiple clients communicably coupled to the one or more of the systems illustrated. When an outbound communication from the business application server 103 is one of an email, fax, or letter, the communication may be received at and/or processed by the target group member system 157, with the communication presented to one or more users associated with the target group member system 157. Where appropriate, the user may use the functionality of the target group member system 157 (e.g., via the client application 169), to respond to a particular campaign outbound. The response can be returned via network 154, and can include a particular PRC to identify the campaign with which the response is associated, as well as the particular communication and responding target group member from which the response is sent.

The GUI 172 associated with each target member system 157 may comprise a graphical user interface operable to, for example, allow the user of a target member system 157 to interface with at least a portion of the business application 133 or other campaign-related application and their associated operations and functionality. Generally, the GUI 172 provides the particular user with an efficient and user-friendly presentation of business data provided by or communicated within the system. The GUI 172 may comprise a plurality of customizable frames or views having interactive fields, pull-down lists, and buttons operated by the user. For example, the GUI 172 may provide interactive elements that allow a user to interact with a particular component within and/or external to environment 100. Different portions of the corresponding component's functionality may be presented and accessible to the user through the GUI 172, such as through the client application 169 (e.g., a web browser). Generally, the GUI 172 may also provide general interactive elements that allow a user to access and utilize various services and functions of a particular component. In some instances, the client application 169 may be used to access various portions of campaign-related information, as well as one or more views 130 associated with a particular campaign. In some instances, the client application 169 may be an agent or client-side version of the business application 133 or other suitable component. The GUI 172 may present the information of the client application 169 for viewing and interaction. In general, the GUI 172 is often configurable, supports a combination of tables and graphs (bar, line, pie, status dials, etc.), and is able to build real-time portals, where tabs are delineated by key characteristics (e.g., site or micro-site). Therefore, the GUI 172 contemplates any suitable graphical user interface, such as a combination of a generic web browser, intelligent engine, and command line interface (CLI) that processes information in the platform and efficiently presents the results to the user visually.

As used in this disclosure, each target member system 157 is intended to encompass a personal computer, touch screen terminal, workstation, network computer, kiosk, wireless data port, smart phone, personal data assistant (PDA), one or more processors within these or other devices, or any other suitable processing device. For example, each target member system 157 may comprise a computer that includes an input device, such as a keypad, touch screen, mouse, or other device that can accept user information, and an output device that conveys information associated with the operation of one or more business applications 133 or other campaign-related operations, and/or the target group member system 157 itself, including digital data, visual information, or the GUI 172. Both the input and output device may include fixed or removable storage media such as a magnetic storage media, CD-ROM, or other suitable media, to both receive input from and provide output to users of the target group member system 157 through the display, namely, the GUI 172. The target member system's processor 163, interface 160, and memory 166 may be similar to or different from those described in connection with the other components illustrated in FIG. 1, although alternative implementations of one or more of these components may be used, as well as implementations where additional components may also be included.

FIG. 1 also includes one or more clients 175. The clients 175 may be associated with a particular business application 133 or campaign. Each client 175 may be any computing device operable to connect to or communicate with the business application server 103 using a wireline or wireless connection via the network 154, or another suitable communication means or channel. In some instances, the client 175 may be a part of or associated with a business process involving one or more of the business applications 133 and campaigns. For example, a particular client 175 may be associated with an administrator, creator, developer, manager, or other user associated with the operation of one or more campaigns. By accessing the business application server 103 using the client 175, the users associated with the client 175 can review the progress of and data associated with a particular campaign, as well as to modify the operations associated with an executing or to-be executed campaign. Users associated with the client 175 may be able to access and review one rom ore views 130 on collected campaign data, as well as define new views and queries to be associated with a particular campaign.

In general, each client 175 includes a processor 181, an interface 178, a client application 187, a graphical user interface (GUI) 190, and a memory 184. In general, the client 175 comprises an electronic computer device operable to receive, transmit, process, and store any appropriate data associated with the environment 100 of FIG. 1. It will be understood that there may be any number of clients 175 associated with, or external to, environment 100. For example, while illustrated environment 100 includes a single client 175, alternative implementations of environment 100 may include multiple clients communicably coupled to the one or more of the systems illustrated. Additionally, there may also be one or more additional clients 175 external to the illustrated portion of environment 100 capable of interacting with the environment 100 via the network 154. Further, the terms “client” and “user” may be used interchangeably as appropriate without departing from the scope of this disclosure. Moreover, while each client 175 is described in terms of being used by a single user, this disclosure contemplates that many users may use one computer, or that one user may use multiple computers.

The GUI 190 associated with each client 175 may comprise a graphical user interface operable to, for example, allow the user of a client 175 to interface with at least a portion of the business application 133 and/or the campaign-related data, information, and attributes. Generally, the GUI 190 provides the particular user with an efficient and user-friendly presentation of business data provided by or communicated within the system. The GUI 190 may comprise a plurality of customizable frames or views having interactive fields, pull-down lists, and buttons operated by the user. For example, the GUI 190 may provide interactive elements that allow a user to interact with a particular component within and/or external to environment 100. Different portions of the corresponding component's functionality may be presented and accessible to the user through the GUI 190, such as through a client application 187 (e.g., a web browser). Generally, the GUI 190 may also provide general interactive elements that allow a user to access and utilize various services and functions of a particular component. In some instances, the client application 187 may be used to access various portions of the business application server 103. In some instances, the client application 187 may be an agent or client-side version of the business application 133 or other suitable campaign-related component. The GUI 190 may present the information of the client application 187 for viewing and interaction. In general, the GUI 190 is often configurable, supports a combination of tables and graphs (bar, line, pie, status dials, etc.), and is able to build real-time portals, where tabs are delineated by key characteristics (e.g., site or micro-site). Therefore, the GUI 190 contemplates any suitable graphical user interface, such as a combination of a generic web browser, intelligent engine, and command line interface (CLI) that processes information in the platform and efficiently presents the results to the user visually.

As used in this disclosure, each client 175 is intended to encompass a personal computer, touch screen terminal, workstation, network computer, kiosk, wireless data port, smart phone, personal data assistant (PDA), one or more processors within these or other devices, or any other suitable processing device. For example, each client 175 may comprise a computer that includes an input device, such as a keypad, touch screen, mouse, or other device that can accept user information, and an output device that conveys information associated with the operation of the client application 187, the business application 133, other components within the business application server 103, and/or the client 175 itself, including digital data, visual information, or the GUI 190. Both the input and output device may include fixed or removable storage media such as a magnetic storage media, CD-ROM, or other suitable media, to both receive input from and provide output to users of client 175 through the display, namely, the GUI 190. The client's processor 181, interface 178, and memory 184 may be similar to or different from those described in connection with the other components illustrated in FIG. 1, although alternative implementations of one or more of these components may be used, as well as implementations where additional components may also be included.

FIG. 2A provides an illustration 200 of an entity relationship model between business objects associated with campaign contact tracking Five different BOs are illustrated: a campaign BO 204, an email activity BO 234, a letter activity BO 240, a fax activity BO 246, and a phone call activity BO 252. Each of the activity BOs (i.e., the email activity BO 234, the letter activity BO 240, the fax activity BO 246, and the phone call activity BO 252) are associated with portions of the outbound relevant portion 213 and the inbound relevant portion 225 of the campaign BO 204.

As illustrated, campaign BO 204 includes a root node 207, with various subordinate nodes. The root node 207 can be used, in instantiations of the campaign BO 204, to define various attributes associated with the corresponding campaign, including possible response options and their associated semantic meaning. The target groups and group members associated with a particular campaign can also be assigned within the root node 207 (or any suitable other subordinate node). The root node's 207 subordinate nodes include a key performance indicator subordinate node 210, an outbound marketing activity subordinate node 216, and an inbound marketing activity business transaction document (BTD) reference subordinate node 228.

The key performance indicator subordinate node 210 keeps calculated key performance indicators (KPIs) which can measure the performance of a campaign, including the number of successful outbound communications, the number of responses received, the response rate to a particular campaign or set of outbound communications, as well as other relevant KPIs.

During campaign execution, an instance of the outbound marketing activity subordinate node 216 is created for each target group member assigned to the campaign. In addition to the information as to the account and/or contact person who was contacted, the instantiated outbound marketing activity subordinate node 216 can store information as to whether or not a particular contact was successful. In instances where a contact is not successful, information related to the reason for the failed contact can be stored there, as well. For instance, if an email outbound communication was sent, the corresponding failure codes and explanation to a failed communication can be stored for later use.

The outbound marketing activity subordinate node 216 includes two subordinate nodes of its own, an outbound marketing activity overview node 219 and an outbound marketing activity BTD reference node 222. The outbound marketing activity BTD reference node 222 is associated with activities generated during campaign execution. An instance of the outbound marketing activity BTD reference node 222 is created in response to generated activities (i.e., when a new outbound communication is generated). The instance of the outbound marketing activity BTD reference node 222 keeps an association to the generated activity. Using this defined association, navigation to the generated activity is possible. The outbound marketing activity overview node 219 may be a query retrieve transformation node (QRTN), which is used to model a particular view based on the outbound marketing activity subordinate node 216 and the outbound marketing activity BTD reference node 222. In other words, the information associated with those two nodes can be provided in a defined view (i.e., view 130 of FIG. 1) and provided for near real-time reporting and analysis within an in-memory database.

For each inbound communication that is a campaign response, an instance of the inbound marketing activity business transaction document (BTD) reference subordinate node 228 is created. A reference to the campaign response is added to the instance, allowing for easy navigation. Additional information, including the date/time that the response was received and information on the contents of the response, can be stored in the created instance. The inbound marketing activity overview node 231 is a subordinate node of the inbound marketing activity BTD reference node 228, and is a QRTN used to model a view based on the instantiated inbound marketing activity BTD reference nodes 228.

As illustrated, each of the activity BOs includes a corresponding root node. Those root nodes are associated with both the outbound marketing activity BTD reference node 222 and the inbound marketing activity BTD reference node 228, allowing the campaign inbound communications associated with particular instances of the activity BOs to be communicated to and linked with the corresponding campaign BO instance 204. By relating these entities, a CT table associated with the particular campaign can track both outbound and inbound campaign communications.

While FIG. 2A is illustrated as including activity BOs, a person of skill in the art would also understand that additional and/or alternative response-related business objects, such as those related to opportunities, leads, sales orders, and/or sales quotes, among others, may also be included in alternative implementations. Those alternative business objects may also be associated with the campaign BO 204, allowing for additional functionality and information to be included in and/or associated with campaigns.

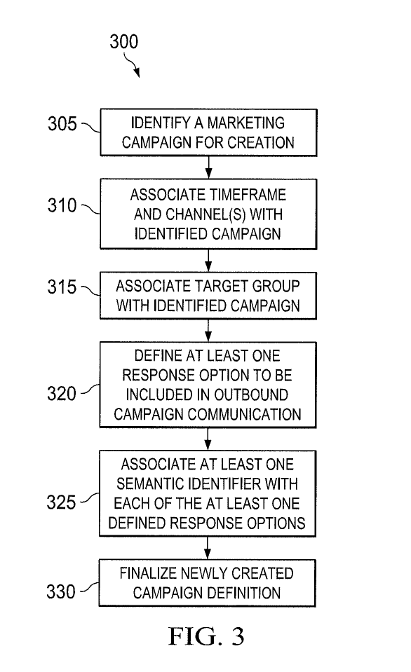

FIG. 3 is a flowchart of an example method 300 for defining, or modeling, a campaign. For clarity of presentation, the description that follows generally describes method 300 in the context of environment 100 illustrated in FIG. 1. However, it will be understood that method 300 may be performed, for example, by any other suitable system, environment, or combination of systems and environments, as appropriate.

At 305, a marketing campaign is identified for creation. In some instances, the marketing campaign may be identified (or modeled) by a person or group of persons associated with the company or entity for which the marketing campaign will be run. In other instances, a marketing firm or other third-party entity may identify the marketing campaign to be created. At 310, a timeframe and communication channels, along with other campaign attributes, are associated with the campaign. Additional attributes may include communication wave-related information, such as a defined time for follow-up communications when no inbound responsive communication is received, as well as return communications for when an inbound communication indicates that additional information is desired by the contact, as well as when a particular response may trigger additional communications. At 315, a particular target group is associated with the identified campaign. The target group can comprise a list of a plurality of persons, entities, contacts, addresses, and other items that define the persons to be associated with a particular campaign. In some instances, one or more members of a target group may be identified based on previous business transactions performed with the entity associated with the campaign, while in others, one or more members of the target group may be contacts acquired from a third-party entity specializing in identifying possible leads and contacts.

At 320, at least one response option to be included with outbound communications for the campaign can be defined. The response option can include options that specify how an individual or entity who has been contacted as part of a campaign can respond to that campaign communication. The response option may contain identifying and administrative information, as well as the possible options to respond to a campaign. In some instances, multiple response options may be defined to be included within a communication. Further, different response options may be provided to different target group members associated with a particular campaign based on one or more attributes or information about the different target group members. In some instances, no response options may be associated with an outbound communication. In those instances, a return communication from the associated target members may be viewed as a response option itself, with the fact that a response is received being considered a positive or, in some cases, a negative response. When a response option is included with a particular outbound communication, that information may be later presented to the receiving individual as a set of options, such as a radio button or checkboxes (when provided via email or an online survey or questions and answer), as well as a set of listed potential answers when sent by fax or letter. When the outbound communication is sent by phone, the response options may be read or provided verbally to the person being contacted for selection.

At 325, at least one semantic identifier can be associated with one or more of the at least one defined response options. Semantic identifiers provide a semantic meaning and association to each of the defined response options. For example, while a particular response option may be defined as “I′m possibly to very possibly interested,” the associated semantic identifier may be “positive,” thereby providing a clear analysis of the context of the answer. By associating these semantic identifiers to the corresponding response options, immediate and easy tracking of campaign contacts are possible. The specific semantic identifiers are therefore defined and associated with the response options at 325, and provide greater context to campaign responses and inbound communications. At 330, the newly created campaign definition is finalized, and the defined attribute and other information can be stored for later use and execution.

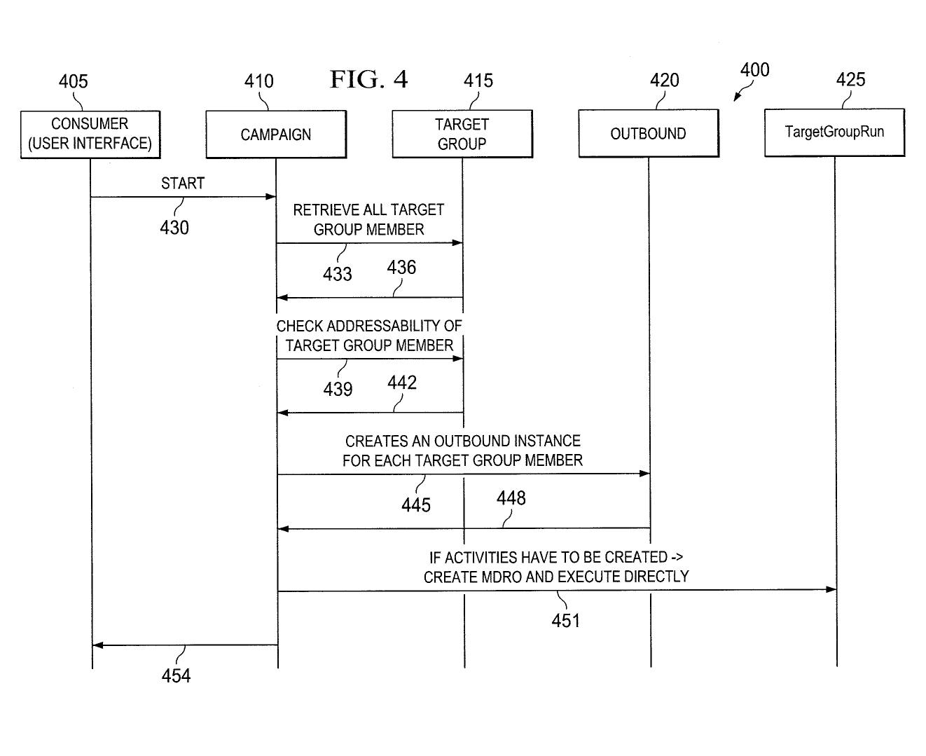

FIG. 4 illustrates an example process 400 for outbound communication tracking during the execution of a particular campaign. For clarity of presentation, the description that follows generally describes method 400 in the context of environment 100 illustrated in FIG. 1. However, it will be understood that method 400 may be performed, for example, by any other suitable system, environment, or combination of systems and environments, as appropriate.

The illustrated entities in FIG. 4 include a consumer 405 who is requesting the execution of a particular campaign, the execution state of the particular campaign 410, a target group 415 associated with the particular campaign and providing the relevant information for contacting a particular campaign participant, a campaign outbound agent 420 for creating outbound communication instances, and a target group run 425. As illustrated by arrow 430, the consumer 405 requests the execution of the particular campaign 410, beginning the outbound tracking process within the execution of the particular campaign. In some instances, the request may be received through a UI associated with campaign execution, such as the GUI 190 of a client 175.

As illustrated by arrow 433, all members of the target group 415 assigned to the campaign 410 are retrieved. This is the basis for the customers, contact persons, and addresses for which outbound communications will be generated. The retrieved information on target group members is returned, as illustrated by arrow 436. In some instances, and as illustrated in FIG. 4, the addressability of each target group member is checked to determine whether that member (through its defined contact information) can be contacted for the campaign based on the communication channel or channels specified for the campaign, as illustrated by arrow 439. The results of that check are returned, as illustrated by arrow 442.

For each target group member to be contacted, a record representing or corresponding to an outbound instance is created (as illustrated by arrow 445) and stored in a corresponding outbound tracking storage location (such as a corresponding CT table 121 as illustrated and described in FIG. 1). Once completed, operations return to the campaign 410 as illustrated by arrow 448. If the corresponding customer, contact persons, or address associated with a particular target group member cannot be contacted due to a failed addressability check, a detailed reason for the failed communication may be stored in the outbound tracking storage location. An example of possible failure reasons include, but are not limited to, the following:
Account not active;
Contact does not exist;
Contact for account incorrect;
Technical problems;
Phone number missing;
Phone usage not permitted;
Contact not active;
Contacting party not permitted;
Email address missing;
Fax number missing;
Letter address incomplete;
Fax usage not permitted;
Email usage not permitted; and
Account does not exist.

A personal response code (PRC) for each outbound communication is created and stored in the outbound tracking table. The PRC can be generated by a random number generator or any other suitable means for creating a unique identifier. In some instances, the PRC can be generated based in part on multiple identifier combined into a single unique identifier, where, for example, an identifiers associated with the particular campaign and an identifier associated with the receiving customer, customer contact, and/or address, are combined. Additionally, if multiple communications may be used for a particular campaign, a reference or identifier associated with the particular correspondence may be included in the PRC. In some instances, the PRC will be in a human-readable format (e.g., alphanumeric) combining one or more digits (0-9) and letters of the alphabet (A-Z), with some implementations allowing symbols and other characters, where appropriate. Therefore, if the PRC is to be entered manually or repeated verbally, the PRC can be spoken via a natural language explanation.

If desired in the business use case of the executed campaign 410, a new backend process for creating activities can be triggered as illustrated by arrow 451. The backend process can work with several parallel tasks to enhance campaign performance. In other words, the activities will not be created in the same work process as all other steps in the corresponding outbound agents for performance reasons. Arrow 454 provides an indicator back to the consumer 405 that the process is complete.

Outbound communications can be tracked in one or more database tables. In some instances, the outbound communication tracking table (e.g., within the CT table 121) can contain one or more of the following fields: (a) a client or application in which the outbound communication generation process was triggered or begun, (b) a field associated with the PRC included within the outbound communication, (c) an identifier associated with a particular execution step or process within the corresponding campaign, (d) an identifier for the particular business partner or entity from the target group to whom the outbound communication is sent or is to be sent, (e) an identifier associated with the particular contact address or individual associated with the business partner or entity from the target group, (f) a creation date of the outbound communication, (g) a reason for failed contact, if necessary), (h) an identifier associated with the outbound communication itself, and (i) a description of the outbound communication, as well as other suitable fields. Additionally, the outbound fields may also include an identification of the possible response options included within the outbound communications. In some instances, these fields (and others) may be populated during the illustrated operations of 445.

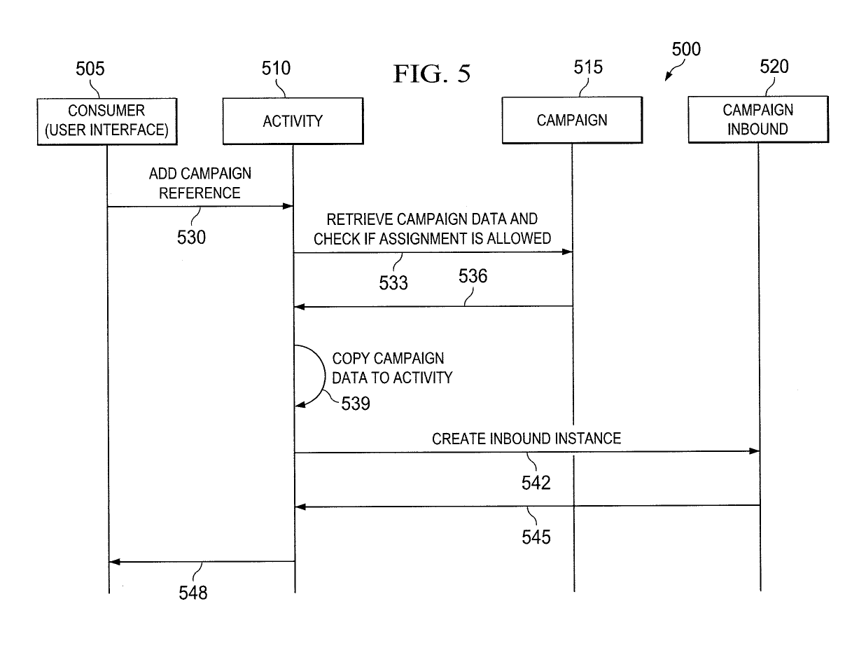

FIG. 5 illustrates an example inbound tracking method 500 for tracking received inbound communications associated with a particular campaign. For clarity of presentation, the description that follows generally describes method 500 in the context of environment 100 illustrated in FIG. 1. However, it will be understood that method 500 may be performed, for example, by any other suitable system, environment, or combination of systems and environments, as appropriate.

The inbound communication may be considered a reaction from a customer, business partner, contact person, or other entity or individual contacted through the campaign. The inbound tracking method 500 is started when the reaction is created within the system. Examples may include (1) assigning a campaign to an inbound activity (e.g., an incoming email, fax, letter, or phone communication), or a response specifically submitted to and added to a particular campaign within or associated with the campaign system, such as a user submitting a response directly via a client application 187 associated with the business application 133 associated with the campaign.

Turning to FIG. 5, as illustrated by arrow 530, a campaign reference is added to an inbound communication to associate the communication with the particular campaign 515, as appropriate. In response, or as previously performed, an inbound activity 510 is associated with the inbound communication. The inbound activity 510 can then, as illustrated by arrow 533, retrieve campaign data to determine if an assignment to the identified campaign 515 is allowed. The determination may be performed by an existence check used to determine whether the campaign lifecycle status allows an assignment between the received response and the campaign 515. For example, if the campaign 515 has ended, the response may not be added to the corresponding inbound table of the corresponding CT table 121, as the inbound communication is not to be associated with the campaign 515 and its prior results. In other instances, the attempted campaign assignment may fail based on an incorrect assignment to the particular campaign 515 (e.g., through a typographical or processing error), as well as any other suitable reason. Arrow 536 illustrates the results of the existence check being returned to the activity 510, as well as information associated with the particular campaign 515.

As illustrated by arrow 539, the attributes, data, and other information associated with the campaign are copied into the activity 510 for use in storing the inbound communication information. The campaign information may overwrite a portion or all of the campaign-related information within the activity 515, as appropriate.

Arrow 542 illustrates the creation of an inbound communication instance, or a campaign inbound instance 520. At this operation, a record can be stored in the inbound tracking storage portion of the CT table 121, or any other location where inbound communication data is stored. If the inbound communication can be assigned to or associated with a particular outbound record of the same campaign instance, then the inbound communication instance record can include a reference to the previously-created outbound record. In some cases, the association of the inbound communication and the previous outbound record associated with a particular outbound communication can be based on the PRC included with both the inbound and the outbound communications. Arrow 545 illustrates that a campaign inbound 520 is created, and arrow 548 allows the consumer 505 or other system user to confirm that the inbound communication has been associated with a particular campaign 515 and its information tracked.

Inbound communications can be tracked in one or more database tables. In some instances, the inbound communication tracking table (e.g., within the CT table 121) can contain one or more of the following fields: (a) a client or application in which the inbound communication generation process was triggered or begun, (b) a field associated with the PRC included within or provided with the inbound communication, (c) an identifier of the related outbound communication or associated record, (d) an identifier provided for the incoming communication, (e) a description of the incoming communication, (f) an identifier for the particular business partner or entity from the target group from whom the inbound communication was sent, (g) an identifier associated with the particular contact address or individual associated with the business partner or entity from the target group, (h) a creation date of the inbound communication and/or its associated inbound record, and (g) an identifier associated with the particular response option or options selected by the sender of the inbound communication. Additional, different, and/or fewer fields may be included in the inbound communication tracking table in different implementations.

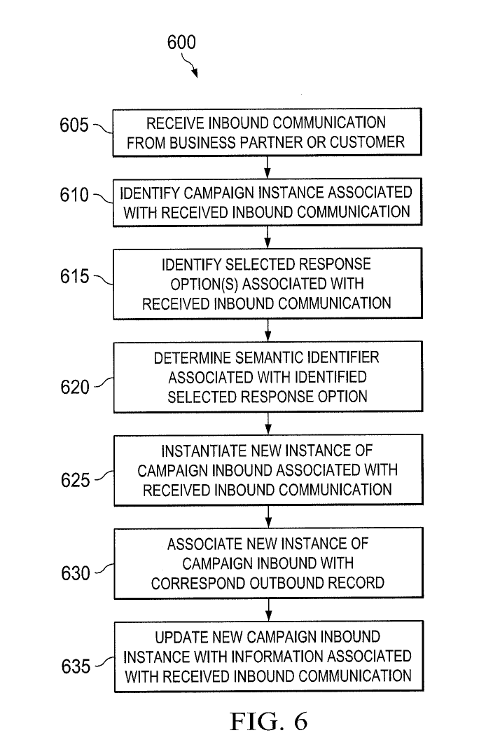

FIG. 6 is a flowchart of an example method 600 for storing information associated with inbound communications that are associated with a particular campaign. For clarity of presentation, the description that follows generally describes method 600 in the context of environment 100 illustrated in FIG. 1. However, it will be understood that method 600 may be performed, for example, by any other suitable system, environment, or combination of systems and environments, as appropriate.

At 605, an inbound communication is received from a business partner, customer, or other contact associated with a campaign. In most instances, the entity or individual who provides the inbound communication will generally have been the direct recipient of the corresponding outbound communication for the campaign, where the outbound communication provided information, such as a PRC, that defined which campaign or campaign instance with which the communications are associated. The information included within the inbound communication, as well as any other suitable information, can be used at 610 to determine and identify the particular campaign instance with which the received inbound communication is associated. In some instances, the PRC (or a portion thereof) may be used to identify the corresponding campaign instance associated with the communication.

At 615, the selected response option(s) associated with the received inbound communication are identified. The selected response options may be identified based on selections made by the responding entity, or by other indications or identifiers. Depending on the question or options provided, only one or multiple response options may be selected. As previously described, each response option may be associated with a particular semantic identifier to provide additional semantic meaning to particular answers to allow for easier and quicker understanding and processing of campaign results. For instances where semantic identifiers are associated with the set of response options, at 620 the associated semantic identifier associated with the identified response options can be determined. In some instances the determination may include referencing a stored campaign definition providing the corresponding semantic identifiers.

At 625, a new instance of a campaign inbound associated with the received inbound communication is instantiated. The instantiated instance of the campaign inbound can be used to store a set of records and information associated with the corresponding inbound communication. In some instances, the instantiation may represent or be accompanied by a new entry within an inbound tracking table, such as within a CT table 121 as illustrated in FIG. 1, where the information included in and relevant to the inbound communication can be stored for campaign analysis and result calculations, as well as for later operations, to be performed.

At 630, the new instance of the campaign inbound can be associated with a corresponding campaign outbound record. In some instances, this association can be based upon matching PRCs shared between an inbound and an outbound communication and the corresponding records of each. Other suitable methods of matching and associating campaign inbound and outbound records can also be used, including deriving the associated inbound and outbound records based, for example, on a comparison of outbound recipient and inbound senders. At 635, the new campaign inbound instance and its related record can be updated with a set of information associated with the received inbound communication.

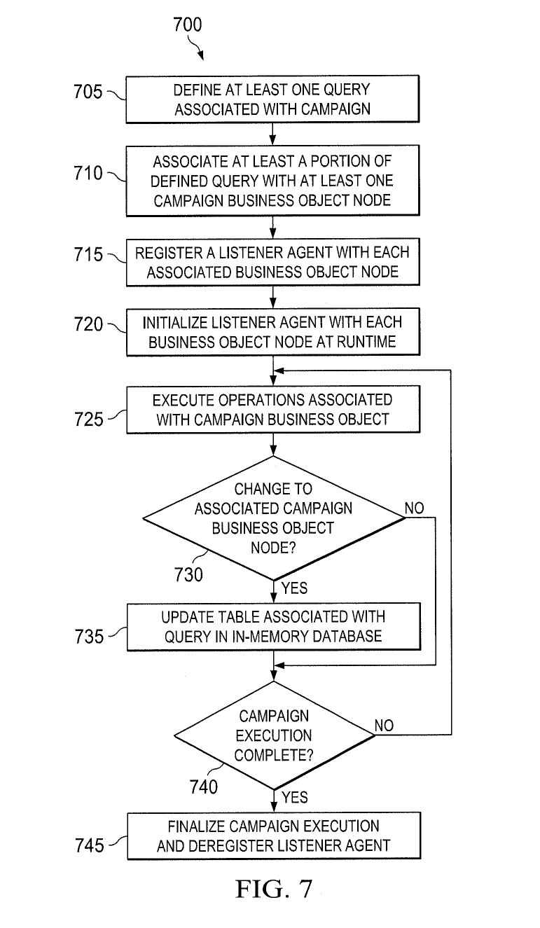

FIG. 7 illustrates an example method 700 for modeling a query associated with one or more campaigns. For clarity of presentation, the description that follows generally describes method 700 in the context of environment 100 illustrated in FIG. 1. However, it will be understood that method 700 may be performed, for example, by any other suitable system, environment, or combination of systems and environments, as appropriate.

At 705, a query associated with a particular campaign is defined. Queries can be defined for a single campaign instance, or all instances of a particular campaign. In general, queries can be defined with both search- and return- parameters, and, in certain instances, can be associated with one or more in-memory database tables. To better enable in-memory queries, a query can be associated with one or more business object nodes associated with the campaign's business object at 710. Changes to those associated business nodes can be identified and the in-memory database can be updated, thereby allowing the associated query to be updated with new information. These changes can be monitored by registering a listener agent with each business object node associated with the particular query at 715. The listener agent can perform operations to identify when the information associated with a monitored business object node is modified in primary storage (e.g., memory 112 of FIG. 1), and, when a change to a particular monitored business object node is identified, update that information in an in-memory database (e.g., in-memory database 127 of FIG. 1). At 720, the listener agent may be initialized or begin its monitoring of a particular campaign instance when a campaign instance is executed at runtime, such that the associated business object nodes are monitored while the campaign instance is executed.

At 725, the operations associated with a campaign instance's execution and the corresponding campaign business object instance are performed. Those operations can include sending outbound correspondence and waiting for and receiving inbound communications back from one or more target group members. At 730, a determination is made as to whether any changes or modifications are identified by the listener agent with a monitored campaign business object node. If no modifications are identified, then method 700 moves to 740. If, however, changes or modifications to the monitored business object are identified, then method continues at 735. At 735, the in-memory database table associated with the query is updated, for example, by the listener agent updating the in-memory database with the modified business object node data.

At 740, a determination is made as to whether the campaign instance's execution is complete. If not, method 700 returns to 730 where the campaign instance continues its operations. If, however, the campaign instance's execution is complete, method 700 continues at 745, where the campaign's execution is finalized, including any final updates to the in-memory database, and the listener agent is deregistered, where appropriate.

While not illustrated in FIG. 7, when a query is called by a user or client system at runtime or after a campaign has completed, the information associated with the query can be accessed from the in-memory database storing the relevant information associated with the query and, in some instances, the response can be provided in near real-time due to the use of in-memory solutions and engines.

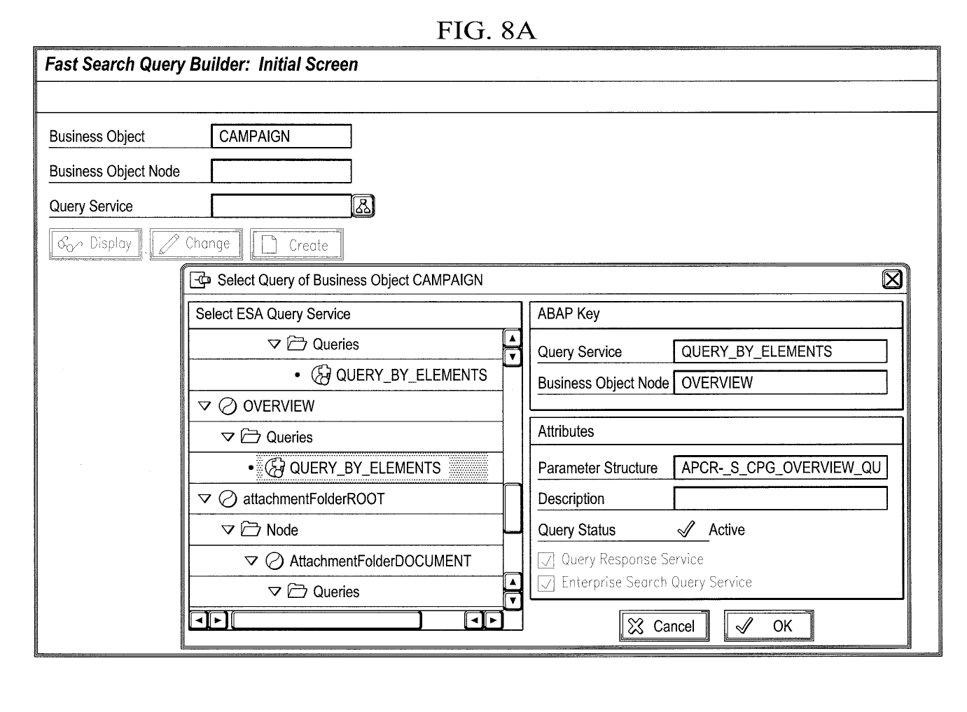

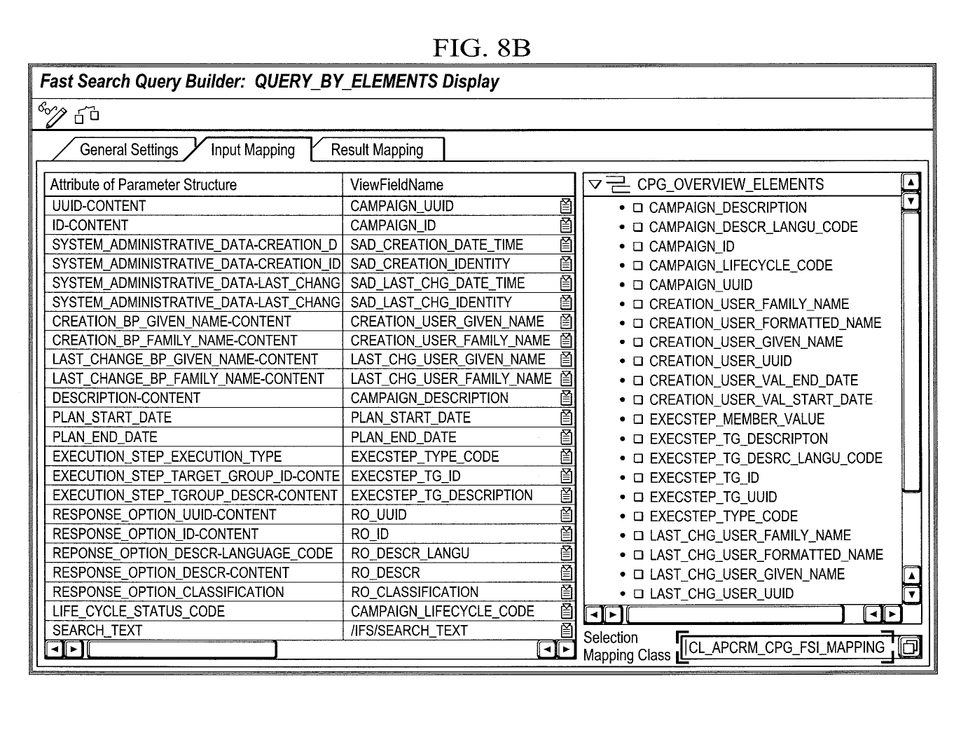

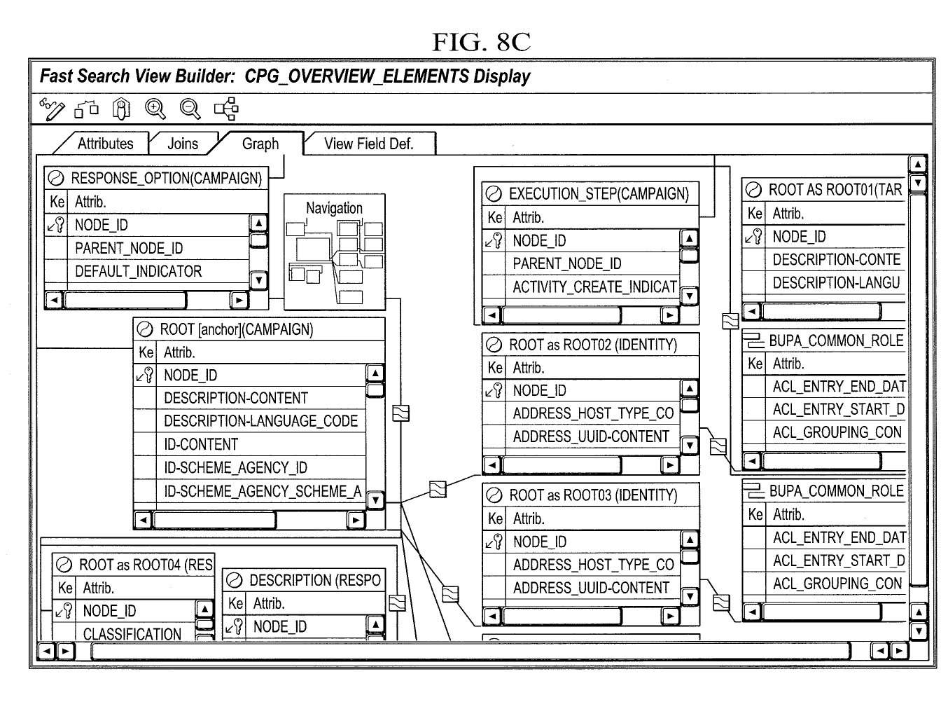

FIGS. 8A-C illustrate example screenshots associated with the modeling of campaign-related queries. FIG. 8A illustrates the assignment of particular business object nodes to a query. As illustrated, the business object to be associated with the query is “CAMPAIGN.” A particular node or set of nodes in the illustrated campaign business object are provided for selection, and a set of query operations are provided for selection. FIG. 8B illustrates the mapping of input parameters for the query to determine how the query is to be called and what input parameters are needed to request and execute the query. FIG. 8C illustrates how relevant business object node attributes will be mapped together in a graphical view builder.

The benefits of the described campaign contract tracking include numerous use cases. Several illustrative use cases are described herein, including a KPI calculation use case, providing a set of response and execution details of a particular campaign, using campaign response information for target group selection, creating a customer fact sheet for particular target group members, and evaluating the quality of target group contact information.

In the KPI calculation use case, information can be derived from the information stored in the campaign contact tracking outbound and inbound tables. Information associated with a particular campaign instance can be identified and aggregated to various key figures to provide various measures of campaign performance. The retrieval of this data can be based, at least in part, upon in-memory data gathering using one or more defined queries. Examples for key figures may include one or more of the following:
Members contacted (=Number of successful outbound communications)
Members not contacted (=Number of unsuccessful outbound communications)
Total number of responses (=Number of inbound records for the particular campaign instance)
Responders (=Number of target group members who reacted/responded to a campaign outbound communication)
Non responders (=Number of contacted target group members who have not yet reacted/responded)
Response rate (=Number of inbound communications divided by number of successful outbound communications)
Positive/negative/neutral responses (=semantic classification of each response to the campaign instance)

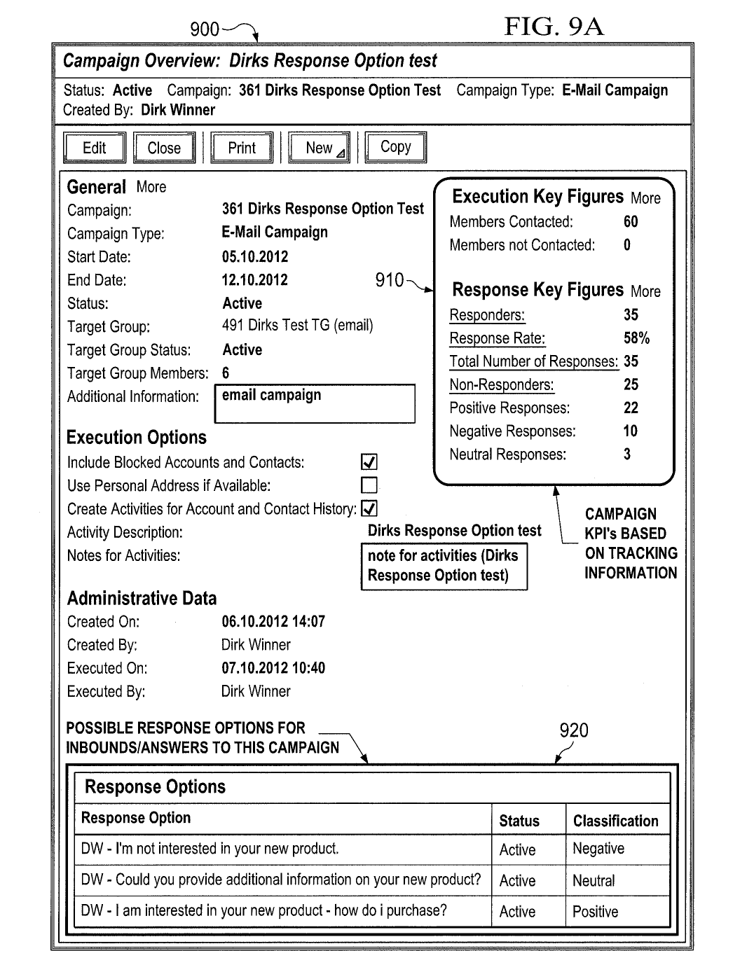

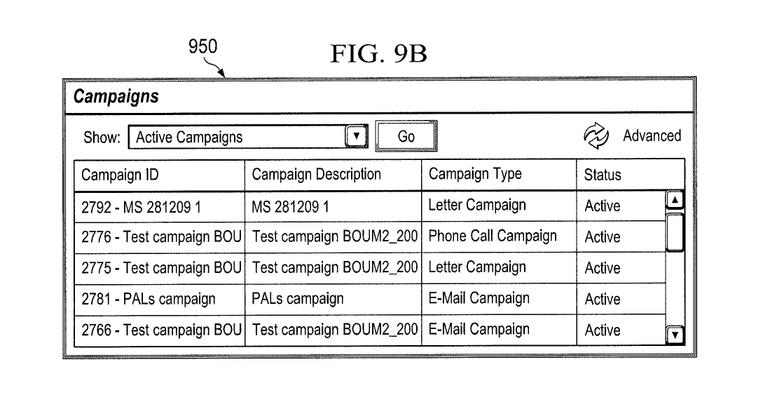

Key figures can be presented, for example, on a campaign overview screen to immediately provide users associated with a particular campaign instance an at- a-glance set of analytics. FIG. 9A provides an illustration 900 for an example campaign and its set of general KPIs. Additional, different, and/or more detailed sets of data can be added by defining additional or different queries for various sets of campaign-related information. As illustrated in FIG. 9A, the KPI metrics illustrated in 910 provide those based on various campaign contact tracking data, including an analysis of the semantic meaning associated with the inbound communications and their particular selected response options. The items in box 920 provide a quick definition of what the provided response options are so that users can quickly determine what the response options were, as well as how those answers were semantically classified. This information can be used to initiate follow-up processes and procedures, or to provide information on how to refine existing campaigns.

In a second use case, the campaign contact tracking enables users and those associated with a particular campaign to have a detailed view on single outbound and inbound entries. Examples of how this information can be used include:
Identifying and showing a list of all customers for whom the creation of an outbound communication failed, including the reason why it failed.
Identifying and showing a list of all customers for whom outbound communications were created, but did not respond to the campaign.
Identifying and showing a list of all customers who answered in a semantically “positive” manner to a specific marketing campaign.

By having this information, appropriate follow-up actions can be determined and set up, including address correction for a particular customer and preparing a follow-up campaign for non-responders and/or positive responders. In some instances, this information may be automatically provided to the campaign execution, and can automatically cause additional actions to be performed with the campaign. For example, a second wave of the campaign can be defined to provide rules for how this information can be used, specifically, by providing parameters for second, third, and additional waves of communication, where appropriate.

A third example use case for campaign tracking is the use of campaign response information in the selection of target groups for later or follow-up campaigns. Inbound communication information can be used to define new or amended target groups which, in turn, can be used in follow-up campaigns and/or identified as individuals or entities who may be viable targets for other related and/or unrelated campaigns. For example, customers who responded positively within a specific time frame may be added to a new group. Any other suitable set of parameters based on the campaign response information can be used to identify additional, new, or revised target groups.

A fourth example use case offers a customer or target group member-centric analysis associated with campaign tracking Specifically, the contact tracking can provide the ability for users to identify a list of all campaigns including the particular of a particular target group member or customer. FIG. 9B provides an example screenshot 950 of the active campaigns for a particular user. Inactive and completed campaign information can also be provided.

A fifth example use case can be performed where one or more email addresses have been purchased by a third party for marketing purposes. When purchased email addresses are used to define a particular target group for a campaign, the number of failed contacts and/or erroneous contact information can be gathered based on the included contact information. If certain quality metrics associated with the purchased email addresses are not met, the purchasing party can easily identify the deficiency and contact the selling third party for a refund and/or correction. The collected information and analytics provided by the described system can include the quality of the external address data received from the third party, a complete contact tracking history used to fulfill legal requirements in some jurisdictions, and a detailed status for analytical reporting of persons and individuals, both for quality purposes as well as for follow-up processes, for correcting any incorrect or insufficient sets of contact information.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer program product for campaign contact tracking, the computer program product comprising computer readable instructions embodied on tangible, non-transitory media, the instructions operable when executed to:
identify an inbound communication from a responding entity associated with a particular campaign, the inbound communication associated with at least one outbound communication associated with the particular campaign;
identify at least one selected response option in the inbound communication;
associate the identified at least one selected response option with a corresponding semantic meaning defined for the particular campaign; and
instantiate a new instance of a campaign inbound object associated with the identified inbound communication, the new instance of the campaign inbound object associated with a set of information related to the inbound communication.

2. The computer program product of claim 1, wherein the identified inbound communication is associated with a unique identifier associated with the responding entity.

3. The computer program product of claim 2, wherein the unique identifier associated with the responding entity is included in at least one outbound communication associated with the particular campaign previously sent to the responding entity.

4. The computer program product of claim 3, further comprising associating the identified inbound communication with a particular previously sent outbound communication associated with the particular campaign based on a matching of the unique identifier referenced in the identified inbound communication with the unique identifier included in the previously sent particular outbound communication.

5. The computer program product of claim 4, wherein associating the identified inbound communication with at least one outbound communication includes adding at least a portion of the information associated with the particular outbound communication in the new instance of the campaign inbound object.

6. The computer program product of claim 1, wherein identifying the inbound communication from the responding entity associated with the particular campaign further includes associating the inbound communication with the particular campaign based, at least in part, on a unique identifier associated with the identified inbound communication.

7. The computer program product of claim 1, wherein the outbound communication includes a plurality of selectable response options, and further wherein each selectable response option is associated with a corresponding, pre-defined semantic meaning

8. The computer program product of claim 7, wherein the semantic meaning associated with each selectable response option is used, after identification of the inbound communication including the at least one selectable response option, to determine a second operation to be performed in the particular campaign.

9. The computer program product of claim 1, further comprising:
analyzing a plurality of campaign inbound object instances to determine at least one statistic associated with the semantic meanings corresponding to the selected response options of each campaign inbound object; and
presenting the results of at least one analysis of the plurality of campaign inbound object instances via a user interface.

10. A computer-implemented method performed by one or more processors for campaign contact tracking, the method comprising the following operations:
identifying an inbound communication from a responding entity associated with a particular campaign, the inbound communication associated with at least one outbound communication associated with the particular campaign;
identifying at least one selected response option in the inbound communication;
associating the identified at least one selected response option with a corresponding semantic meaning defined for the particular campaign; and
instantiating a new instance of a campaign inbound object associated with the identified inbound communication, the new instance of the campaign inbound object associated with a set of information related to the inbound communication.

11. The method of claim 10, wherein the identified inbound communication is associated with a unique identifier associated with the responding entity.

12. The method of claim 11, wherein the unique identifier associated with the responding entity is included in at least one outbound communication associated with the particular campaign previously sent to the responding entity.

13. The method of claim 12, further comprising associating the identified inbound communication with a particular previously sent outbound communication associated with the particular campaign based on a matching of the unique identifier referenced in the identified inbound communication with the unique identifier included in the previously sent particular outbound communication.

14. The method of claim 13, wherein associating the identified inbound communication with at least one outbound communication includes adding at least a portion of the information associated with the particular outbound communication in the new instance of the campaign inbound object.

15. The method of claim 10, wherein identifying the inbound communication from the responding entity associated with the particular campaign further includes associating the inbound communication with the particular campaign based, at least in part, on a unique identifier associated with the identified inbound communication.

16. The method of claim 10, wherein the outbound communication includes a plurality of selectable response options, and further wherein each selectable response option is associated with a corresponding, pre-defined semantic meaning

17. The method of claim 16, wherein the semantic meaning associated with each selectable response option is used, after identification of the inbound communication including the at least one selectable response option, to determine a second operation to be performed in the particular campaign.

18. The method of claim 10, the operations further comprising:
analyzing a plurality of campaign inbound object instances to determine at least one statistic associated with the semantic meanings corresponding to the selected response options of each campaign inbound object; and
presenting the results of at least one analysis of the plurality of campaign inbound object instances via a user interface.

19. A system comprising:
one or more computers; and
a computer-readable medium coupled to the one or more computers having instructions stored thereon which, when executed by the one or more computers, cause the one or more computers to perform operations comprising:
identifying an inbound communication from a responding entity associated with a particular campaign, the inbound communication associated with at least one outbound communication associated with the particular campaign;
identifying at least one selected response option in the inbound communication;
associating the identified at least one selected response option with a corresponding semantic meaning defined for the particular campaign; and
instantiating a new instance of a campaign inbound object associated with the identified inbound communication, the new instance of the campaign inbound object associated with a set of information related to the inbound communication.

20. The system of claim 19, wherein the identified inbound communication is associated with a unique identifier associated with the responding entity, and wherein the unique identifier is included in at least one outbound communication associated with the particular campaign previously sent to the responding entity.
